(19) United States
(12) Patent Application Publication
(10) Pub. No.: US 2004/0047011 A1
(43) Pub. Date: Mar. 11, 2004

(54) Method for multi-job scanning

(75) Inventor: Zhang Xiao Qiu, SuZhou (CN)

Correspondence Address: TROXELL LAW OFFICE PLLC, 5205 LEESBURG PIKE, SUITE 1404, FALLS CHURCH, VA, 22041, US

(73) Assignee: BENQ Corporation

(21) Appl. No.: 10/656,323

(22) Filed: Sep. 8, 2003

(30) Foreign Application Priority Data
Sep. 10, 2002 (TW) 91120533

(51) Int. Cl. G06K 9/54; G06K 9/60; H04N 1/46

(52) U.S. Cl. 358/505; 382/307

(57) ABSTRACT

The present invention provides a method for multi-job scanning used in an optical scanning device. The method comprises: configuring multiple scanning scopes; re-allocating the scanning scopes into multiple scanning areas such that each scanning area covers one of the scanning scopes, part of one of the scanning scopes, or multiple ones or parts of the scanning scopes; determining a scanning order according to the distance from each scanning area to the scanning starting position; configuring the resolution of each scanning area as the highest one of resolution requests of the scanning scopes overlapping with the scanning area; and scanning each scanning area by a CCD of the scanning device according to the scanning order and the configured resolution, where the CCD does not return to the starting position during scanning.

### BACKGROUND OF THE INVENTION

(a). Field of the Invention

The present invention relates in general to multi-job scanning of an optical scanning device, and more particularly to the scanning method where the image-grabbing component of the scanning device need not return to the starting position during scanning.

(b). Description of the Prior Arts

Scanners are common optical scanning devices and utilize the principle of optical transformation to transform images of scanning objects into digital data. The scanners employ a linear light source to illuminate scanned objects, utilize an image-grabbing component to catch the images reflected by the objects, and then transform the images into digital signals for output.

When an end user uses the scanner to scan an object, it is desirable to get the images of several valid areas of the object by scanning, these areas at a time. In this specification, each area of this kind is called a job. A conventional method for multi-job scanning comprises: an image-grabbing component of the scanner (taking CCD as an example below) starting from the scanning starting position, returning to the starting position after finishing only a job and restarting to scan next job. Thus, the CCD would run back and forth n times for n jobs, and this is unfavorable for rapid scanning. Although increasing the speed of the stepping motor that drives the CCD may decrease the scanning time, the decreased time is limited because of the limitation of the stepping motor itself.

FIG. 1 is a diagram which illustrates the conventional method for multi-job scanning. As shown in FIG. 1, there are four areas, assigned as jobs 1 to 4, on the document plate of a scanner, and the CCD follows the order of (1) to (4) to scan the scopes of these four jobs respectively according to the distance from each job to the starting position. The lines with arrows in FIG. 1 show the scanning routes and directions. In this specification, the distance from a job to the starting position, unless another definition is indicated, is referred to the straight length from the starting position to the front edge of the job. When finishing a job, that is, scanning to the rear edge of the job, the CCD would go back to the starting position and then continue to next job. Hence, the scanning speed will slow down substantially. When the number of jobs increases, the performance of the scanner will degrade more seriously.

### SUMMARY OF THE INVENTION

In view of the above issue, the present invention provides a method for multi-job scanning, which enables a scanner to scan multiple jobs without returning its CCD to the starting position during scanning. Thus, the performance degradation due to repeated returns of the CCD could be avoided.

The first embodiment of the method of the present invention re-allocates the scanning scopes of all jobs into multiple scanning areas based on overlapping situations such that each scanning area is regarded as a new job and corresponding to one of the following situations: a. an original job; b. part of an original job; c. including several original jobs or their parts. The resolution of a new job is configured as the highest one of resolution requests of all original jobs overlapping with the new job. In addition, the scanning order is determined according to the distance from each new job to the starting position.

The second embodiment of the method of the present invention determines the scanning order directly according to the distance from the scanning scope of each job to the starting position.

The third embodiment of the method of the present invention precludes the jobs whose scanning scopes overlap in the moving direction of the CCD except the job closest to the scanning starting position, and then determines a first order from the near to the distant for the remaining jobs. Next, a second order is determined from the distant to the near for the precluded jobs according to the distances from the rear edges of them to the scanning starting position. Then, all the jobs are scanned according to the first and second orders respectively.

In the above embodiments, the CCD performs scanning operation according to the resolution of each job (or new job) and the determined order, wherein after finishing a job, the CCD moves directly to next job without returning to the starting position. The scanner further includes a variable-speed stepping motor for driving the CCD. During scanning, the stepping motor accelerates in non-scanning areas to save scanning time and adjusts to an optimal operation speed according to the image type, resolution and scanning scope of each scanning area.

### BRIEF DESCRIPTION OF THE DRAWINGS

FIG. 1 is a diagram which illustrates the conventional method for multi-job scanning.

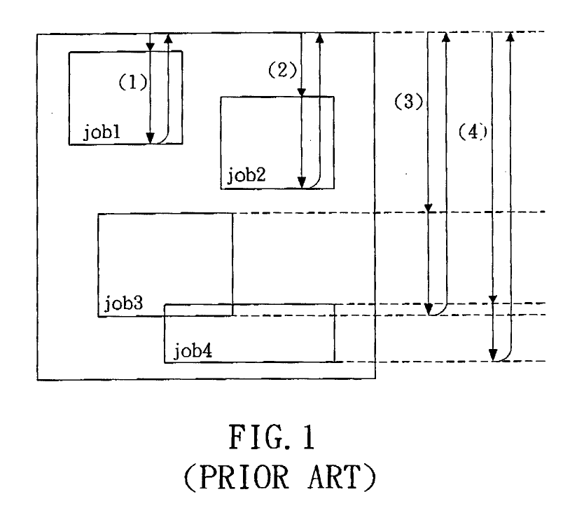

FIG. 2 is a flow chart of the method for multi-job scanning according to the first embodiment of the present invention.

FIG. 3 is a diagram which illustrates an application of the method according to the first embodiment of the present invention.

FIG. 4 is a diagram which illustrates an alternative application of the method according to the first embodiment of the present invention.

FIG. 5 is a flow chart of the method for multi-job scanning according to the second embodiment of the present invention.

FIG. 6 is a diagram which illustrates an application of the method according to the second embodiment of the present invention.

FIG. 7 is a flow chart of the method for multi-job scanning according to the third embodiment of the present invention.

FIG. 8 is a diagram which illustrates an application of the method according to the third embodiment of the present invention.

### DETAILED DESCRIPTION OF THE PRESENT INVENTION

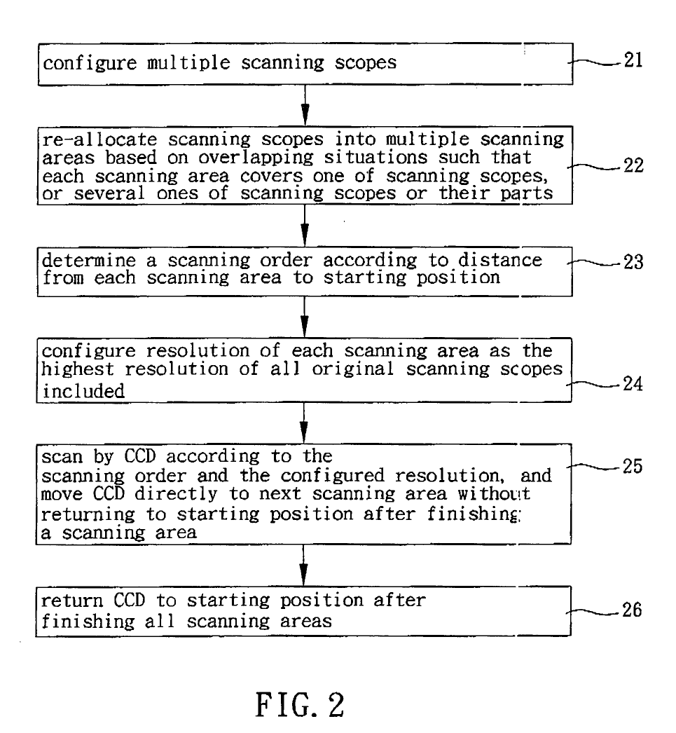

FIG. 2 is a flow chart of the method for multi-job scanning according to the first embodiment of the present invention. As shown in FIG. 2, the method comprises the following steps:

21 configuring multiple scanning scopes in a scanning process;

22 re-allocating the multiple scanning scopes into a plurality of scanning areas based on their overlapping situations such that each scanning area corresponds to one of the following situations: a. covering one of the multiple scanning scopes; b. covering part of one of the multiple scanning scopes; c. covering several ones of the multiple scanning scopes or their parts;

23 determining a scanning order according to the distance from each scanning area to the scanning starting position;

24 configuring the resolution of each scanning area as the highest one of resolution requests of all original scanning scopes overlapping with the scanning area;

25 scanning the scanning areas by the CCD according to the scanning order and the resolution determined in steps 23 and 24 respectively, wherein after finishing a scanning area, the CCD moves directly to next scanning area without returning to the starting position; and

26 returning the CCD back to the starting position after finishing all the scanning areas.

In the first embodiment, each scanning scope is a job and each of the re-allocated scanning area is regarded as a new job. After performing the multi-job scanning, the obtained image data will be processed in the following manner:

(a) if a new job is corresponding to an original job, the image data of the original job is that obtained by scanning the new job.

(b) if a new job is corresponding to part of an original job, then the image data obtained by scanning the new job is filled into the corresponding area of the original job,

(c) if a new job contains several original jobs or their parts, then the image data restoration corresponding to each job/part is performed according to the resolution ratio (i.e. the ratio of the resolution of each job/part to the practical resolution used in scanning), and the restored image data is filled into the corresponding area of each original job.

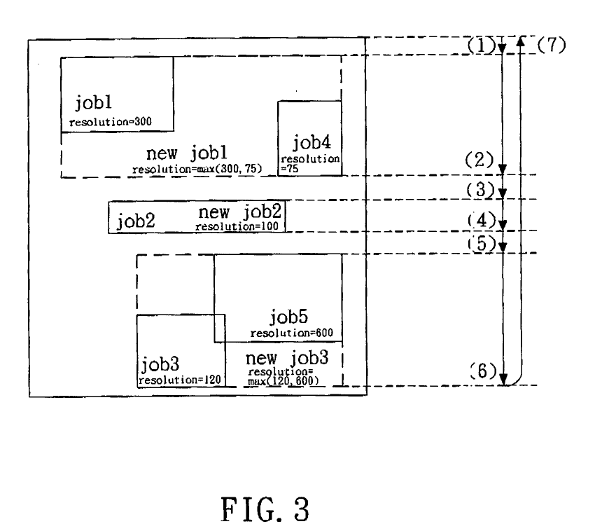

Next, the first embodiment is further explained with two applications. FIG. 3 is a diagram which illustrates an application of the method according to the first embodiment of the present invention. As shown in FIG. 3, the application comprises: (a) In step 22, a smallest square area is determined to cover the scanning scopes of multiple jobs which overlap in the moving direction of the CCD, that is, the CCD would scan at least part of these scanning scopes simultaneously when moving in the scanning process. These jobs are combined into a new job and the scanning scope of the new job is configured as the smallest square area. In FIG. 3, the jobs 1 and 4 are combined as the new job 1; the jobs 3 and 5 are combined as the new job 3. In step 24, the resolution of a new job is configured as the highest one of resolution requests for all original jobs included in the new job. (b) In step 22, a job not overlapping with any other job in the moving direction of the CCD is regarded as a new job. In FIG. 3, the original job 2 is a case of this kind and configured as the new job 2. (c) In step 23, a scanning order is determined from the near to the distant according to the distance from each new job to the scanning starting position.

In steps 25 and 26, the scanning operation is performed according to the assigned numbers (1) to (7) in FIG. 3: (1) the CCD moving from the starting position to the nearest new job 1; (2) scanning the scope of the new job 1; (3) the CCD moving directly to the new job 2; (4) scanning the scope of the new job 2; (5) the CCD moving directly to the new job 3; (6) scanning the scope of the new job 3; and (7) the CCD returning to the starting position.

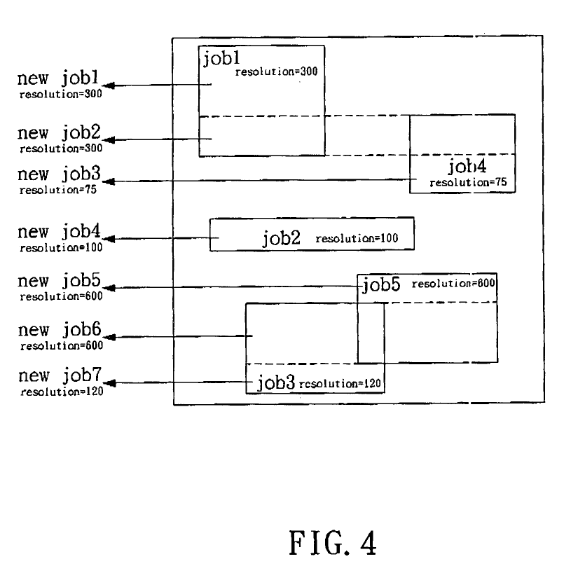

FIG. 4 is a diagram which illustrates an alternative application of the method according to the first embodiment of the present invention. As shown in FIG. 4, the alternative application comprises:

(a) In step 21, five scanning blocks, assigned as jobs 1 to 5, with different resolution are provided in the scanning process.

(b) In step 22, the overlapping parts of the blocks that overlap in the moving direction of the CCD (i.e. jobs 1 and 4, jobs 3 and 5) are isolated, and each of the overlapping parts is regarded as a new job, while each of the remaining jobs or parts (without overlapping each other) is also regarded as a new job. Thus, the five scanning blocks of FIG. 4 are re-allocated as seven scanning areas.

(c) In step 23, the seven scanning areas are assigned as the new jobs 1 to 7 from the near to the distant according to the distance from each new job to the scanning starting position.

(d) In step 24, the resolution of each new job is configured as the highest one of resolution requests of all original jobs overlapping with the new job. For example, the new job 2 overlaps with the original jobs 1 and 4, thus its resolution is the same as the original job 1 which has the highest resolution.

(e) In step 25, the scanning operation is performed as below: (1) the CCD moving from the starting position to the scanning area of the new job 1, and adjusting the stepping motor to an optimal speed according to the image type, resolution and scanning scope of the new job 1; (2) after scanning the new job 1, the motor directly scanning the area of the new job 2; and (3) scanning in the determined order to the new job 7 in the way similar to (2).

The image type here refers to color, grayscale, or black and white. As to the motor speed adjustment, after scanning the new job 3, for example, the motor speeds up to drive the CCD to the front edge of the new job 4 and then restores to a predetermined scanning speed. That is, the motor speeds up in the non-scanning area from the rear edge of the new job 3 to the front edge of the new job 4 to save time.

(f) In step 26, after scanning the new job 7, the motor drives the CCD back to the starting position.

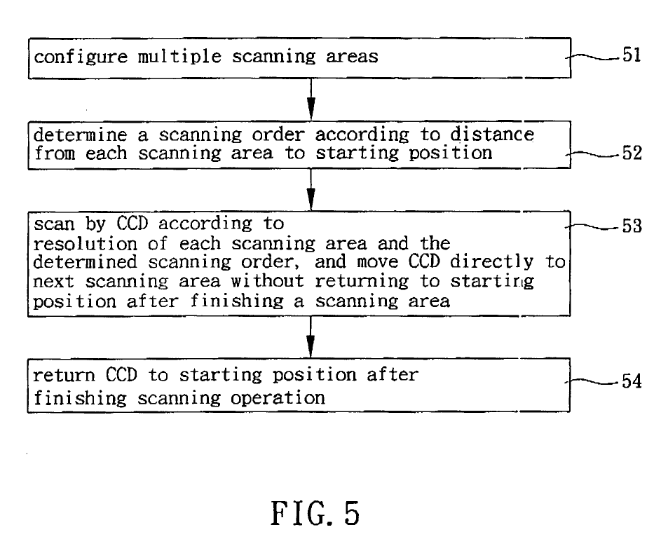

FIG. 5 is a flow chart of the method for multi-job scanning according to the second embodiment of the present invention. As shows in FIG. 5, the method comprises the following steps:

51 configuring multiple scanning areas in a scanning process;

52 determining a scanning order according to the distance from each scanning area to the starting position;

53 scanning the scanning areas by the CCD according to the resolution request of each scanning area and the scanning order determined in step 52, wherein after finishing a scanning area, the CCD moves directly to next scanning area without returning to the starting position; and

54 returning the CCD to the starting position after finishing the scanning operation.

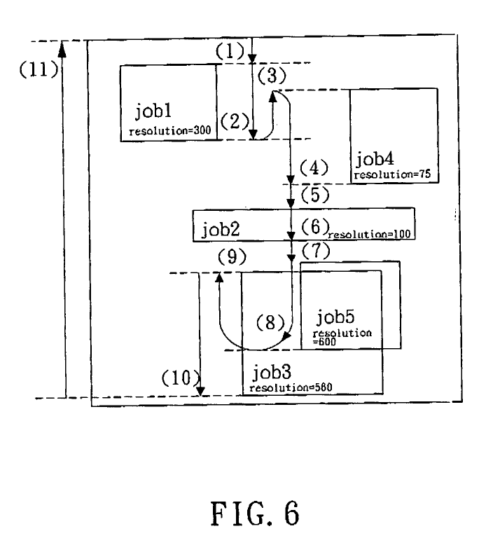

Next, the second embodiment is further explained with an application. FIG. 6 is a diagram which illustrates an application of the method according to the second embodiment of the present invention. As shown in FIG. 6, the application comprises: (a) In step 52, a scanning order is determined from the near to the distant according to the distance from each scanning area to the starting position. (b) In step 53, the CCD starts from the nearest job, and after finishing a job, it moves directly to a next job. Therefore, if the next job overlaps with the job in the moving direction of the CCD, the CCD needs to make a reverse shift. After finishing all the jobs, the CCD returns back to the starting position.

In steps 53 and 54, the scanning operation is performed according to the assigned numbers (1) to (11) in FIG. 6: (1) the CCD moving from the starting position to the nearest job 1; (2) scanning the scope of the job 1; (3) the CCD moving back to the second nearest job 4; (4) scanning the scope of the job 4; (5) the CCD moving forward to the third nearest job 2; (6) scanning the scope of the job 2; (7) the CCD moving forward to the job 5; (8) scanning the scope of the job 5; (9) the CCD moving back to the most distant job 3; (10) scanning the scope of the job 3; and (11) the CCD returning to the starting position.

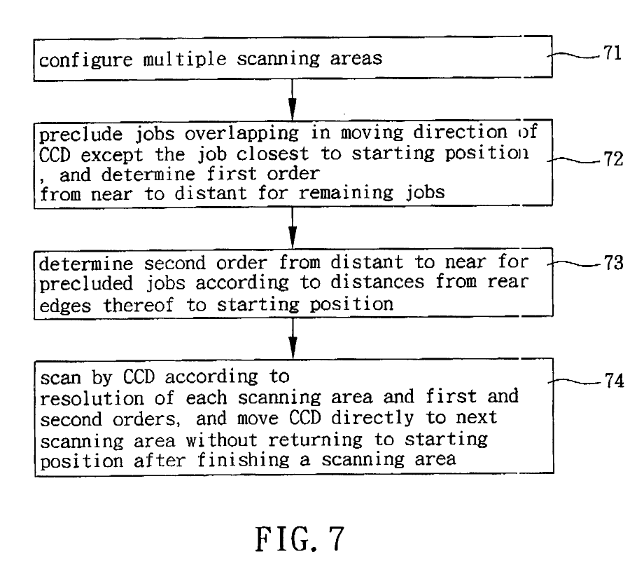

FIG. 7 is a flow chart of the method for multi-job scanning, according to the third embodiment of the present invention. As shown in FIG. 7, the method comprises the following steps:

71 configuring multiple scanning areas in a scanning process;

scanning each of the scanning areas by the image-grabbing component according to the scanning order and a resolution request of the each of the scanning areas, wherein the image-grabbing component moves directly to a next scanning area after finishing a scanning area.

11. The method of claim 10, wherein the scanning order is determined from the near to the distant according to the distance from the each of the scanning areas to the scanning starting position.

72 precluding the jobs whose scanning areas overlap in the moving direction of the CCD except the job closest to the scanning starting position, and then determining a first order from the near to the distant for the remaining jobs;

73 determining a second order from the distant to the near for the precluded jobs according to the distances from the rear edges of them to the scanning starting position; and

74 scanning the scanning areas by the CCD according to the resolution request of each scanning area and the first and second orders, wherein after finishing a scanning area, the CCD moves directly to next scanning area without returning to the starting position.

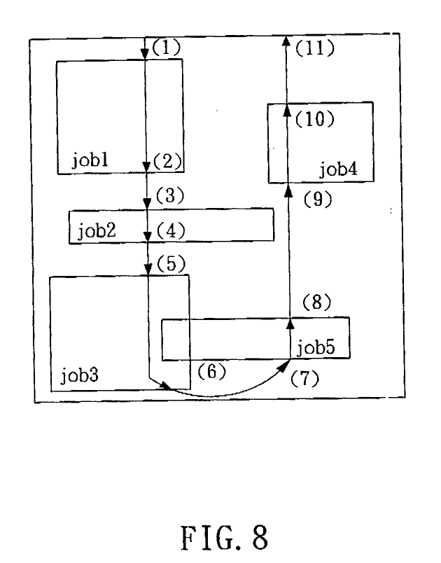

The third embodiment is further explained with an application. FIG. 8 is a diagram which illustrates an application of the method according to the third embodiment of the present invention. As shown in FIG. 8, the application comprises: (a) Each job is scanned separately and in the order determined from the near to the distant according to the distance from the job to the starting position. But if there is any other job overlapping the scanned job in the moving direction of the CCD, then the overlapping job will be bypassed. (b) If there is no other job in the moving direction of the CCD, then the CCD begins to move back and scans the remaining jobs from the distant to the near according to the distances from the rear edges of them to the starting position.

In step 74, the scanning operation is performed according to the assigned numbers (1) to (11) in FIG. 8: (1) the CCD moving from the starting position to the nearest job 1; (2) scanning the scope of the job 1; (3) the CCD bypassing the job overlapping with the job 1 and moving directly to the job 2; (4) scanning the scope of the job 2; (5) the CCD moving directly to the job 3 because the job 2 doesn't overlap with any other job; (6) scanning the scope of the job 3; (7) the CCD moving back to the farthest job 5 of the remaining jobs because there's no other job in the moving direction of the CCD after bypassing the job overlapping with job 3,; (8) scanning the scope of the job 5; (9) the CCD moving back to the second farthest job 4; (10) scanning the scope of the job 4; and (11) the CCD returning to the starting position.

While the present invention has been shown and described with reference to preferred embodiments thereof, and in terms of the illustrative drawings, it should be not considered as limited thereby. Various possible modification, emission, and alterations could be conceived, of by one skilled in the art to the form and the content of any particular embodiment, without departing from the scope and the sprit of the present invention.

What is claimed is;

1. A method for multi-job scanning used in an optical scanning device, the optical scanning device having an image-grabbing component driven in a scanning process between a scanning starting position and a scanning terminal position, the method comprising:
configuring a plurality of jobs in the scanning process;
re-allocating scanning scopes of the jobs into a plurality of scanning areas, wherein each of the scanning areas corresponds to one of following situations: covering one of the scanning scopes, covering part of one of the scanning scopes, and covering multiple ones or parts of the scanning scopes;
determining a scanning order according to a distance from each of the scanning areas to the scanning starting position;
configuring a resolution of each of the scanning areas as a highest one of resolution requests of the scanning scopes overlapping with the each of the scanning areas; and
scanning each of the scanning areas by the image-grabbing component according to the scanning order and the configured resolution, wherein the image-grabbing component moves directly to a next scanning area after finishing a scanning area.

2. The method of claim 1, wherein the image-grabbing component is driven by a variable-speed stepping motor.

3. The method of claim 2, wherein the scanning comprises accelerating the variable-speed stepping motor in non-scanning areas.

4. The method of claim 2, wherein the scanning comprises adjusting a speed of the stepping motor according to image type, resolution and scanning scope of the each of the scanning areas.

5. The method of claim 4, wherein the image type comprises one of the following: color, grayscale, and black and white.

6. The method of claim 1, wherein the re-allocating comprises combining the scanning scopes which overlap in a moving direction of the image-grabbing component to form one of the scanning areas, and isolating the scanning scope which does not overlap with any other scanning scope in the moving direction of the image-grabbing component to form another one of the scanning areas.

7. The method of claim 1, wherein the re-allocating comprises isolating each overlapping portion of the scanning scopes which overlap in a moving direction of the image-grabbing component to form one of the scanning areas, and isolating each remaining portion of the overlapping scanning scopes to form another one of the scanning areas.

8. The method of claim 1, wherein the scanning order is determined from the near to the distant according to the distance from the each of the scanning areas to the scanning starting position.

9. The method of claim 1, further comprising:
returning the image-grabbing component to the scanning starting position after the scanning.

10. A method for multi-job scanning used in an optical scanning device, the optical scanning device having an image-grabbing component driven in a scanning process between a scanning starting position and a scanning terminal position, the method comprising:
configuring a plurality of scanning areas in the scanning process;
determining a scanning order according to a distance from each of the scanning areas to the scanning starting position; and
scanning each of the scanning areas by the image-grabbing component according to the scanning order and a resolution request of the each of the scanning areas, wherein the image-grabbing component moves directly to a next scanning area after finishing a scanning area.

11. The method of claim 10, wherein the scanning order is determined from the near to the distant according to the distance from the each of the scanning areas to the scanning starting position.

12. The method of claim 10, further comprising:
returning the image-grabbing component to the scanning starting position after the scanning.

13. The method of claim 10, wherein the image-grabbing component is driven by a variable-speed stepping motor.

14. The method of claim 13, wherein the scanning comprises accelerating the variable-speed stepping motor in non-scanning areas.

15. The method of claim 13, wherein the scanning comprises adjusting a speed of the stepping motor according to image type, resolution and scanning scope of the each of the scanning areas.

16. The method of claim 15, wherein the image type comprises one of the following: color, grayscale, and black and white.

17. A method for multi-job scanning used in an optical scanning device, the optical scanning device having an image-grabbing component driven in a scanning process between a scanning starting position and a scanning terminal position, the method comprising:
configuring a plurality of scanning areas in the scanning process;
precluding the scanning areas which overlap in a moving direction of the image-grabbing component except the scanning area closest to the scanning starting position, and determining a first order from the near to the distant for the remaining scanning areas;
determining a second order from the distant to the near for the precluded scanning areas according to distances from rear edges of the precluded scanning areas to the scanning starting position; and
scanning each of the scanning areas by the image-grabbing component according to a resolution request of the each of the scanning areas and the first and second orders, wherein the image-grabbing component moves directly to a next scanning area after finishing a scanning area.

18. The method of claim 17, wherein the image-grabbing component is driven by a variable-speed stepping motor.

19. The method of claim 18, wherein the scanning comprises accelerating the variable-speed stepping motor in non-scanning areas.

20. The method of claim 18, wherein the scanning comprises adjusting a speed of the stepping motor according to image type, resolution and scanning scope of the each of the scanning areas.

21. The method of claim 20, wherein the image type comprises one of the following: color, grayscale, and black and white.

22. The method of claim 17, wherein the scanning comprises scanning the scanning areas included in the second order from the rear edges to front edges.
